(19) United States
(12) Patent Application Publication
(10) Pub. No.: US 2007/0041044 A1
(43) Pub. Date: Feb. 22, 2007

(54) Print order system, print order terminal, print order receiving server and print order program

(75) Inventors: Kazuyoshi Tanaka, Tokyo (JP); Masahiko Kamei, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA BUSINESS TECHNOLOGIES, INC., Tokyo (JP)

(21) Appl. No.: 11/446,846

(22) Filed: Jun. 5, 2006

(30) Foreign Application Priority Data
Aug. 19, 2005 (JP) JP2005-238292

(51) Int. Cl. G06F 3/12

(52) U.S. Cl. 358/1.15; 358/452

(57) ABSTRACT

An order terminal transmits print order information including image information and identification information of an image editing software used for image editing to an order receiving server. The order receiving server calculates charging amount for an image editing software supplier in accordance with the print order information and the identification data and executes charging process for the image editing software supplier.

This application is based on Japanese Patent Application No. 2005-238292 filed on Aug. 19, 2005, in Japanese Patent Office, the entire content of which is hereby incorporated by reference.

### FIELD OF THE INVENTION

The present invention relates to technologies for ordering a print of an image through a network.

With the spread of digital cameras, the occasions where the photographic image is handled in a form of digital data have been increasing. Accordingly, services to print a photographic image in digital data have been developed. Among them, the popularization of a network type printing service where the photographic image is transmitted through the network to a terminal handling printing service, is remarkable. The network type printing service handles, for instance, outputting of images suitable for new year greeting cards besides outputting of the photographic images.

In the network type printing service, the image is transmitted to a server which receives an order through network N from a terminal such as a computer owned by an orderer. The server transmits an image to a printing company terminal after proceeding a charging process for the orderer. The printing company outputs the image in a form of print matter and dispatch it to a recipient designated by the orderer (for example, refer to Patent document 1).

The orderer may sometimes edit the image on its own computer before using the printing service. Examples of the edition include, red-eye reduction for the photographic image, and mail articles where the photographic image is laid out at the desired position and characters of a text and address are inserted. The above image editing is carried out by using an image editing software owned by the orderer.

[Patent Document 1] Official Gazette of Japanese Patent Tokkai 2001-344428

In the printing service, there is a demand that various procedures are to be implemented by the order receiving side according to the image editing software which the ordrere used. Examples of the demand include a procedure to change the image data structure peculiar to the image editing software to the data structure matching a printing system of the printing company, a procedure of outputting an image edited along a predetermined purpose in a form of output which accords with the concept of the editing, a service fee charging procedure which charges the service fee to the orderer and the image editing software supplier for these services, and a procedure of charging fee for an increase of added value of the image editing software created by providing the print order function for print service to particular image editing software.

However, in conventional printing service, the information transmitted from orderer is limited to image data, designation of a kind of the printing sheet, the number of prints and the condition of finish, so that it is not easy to identify the image editing software used for editing. Therefore the aforesaid procedures were not feasible.

### SUMMARY OF THE INVENTION

The invention has been attained in view of the above circumstances and an object of the present invention is to provide technologies enabling post-processing which accords with image editing software at order receiving side, and provide technology enabling the charging procedure particularly to the image editing software supplier as a post-process.

The above-mentioned problems are solved by the following items:
Item 1. A print order system, comprising:

an order terminal to transmit print order information having image information, including;
an editing unit which is operated by an image editing software to edit the image information, and
a transmission unit which transmits the print order information as well as an identification data (hereinafter called ID) of the image editing software;

an order receiving server to receive the print order information, including;
a charging unit to calculate a charging amount to be charged to a image editing software supplier based on the print order information, and
a storing unit to store the charging amount in conjunction with the ID.
Item 2. A print order terminal comprising:

an editing unit which is operated by an image editing software to edit the image information; and

a transmission unit which transmits the print order information as well as an identification data (hereinafter called ID) of the image editing software,

wherein the print order terminal is capable of communicating with an order receiving server which receives print order information including image information, and charges to an image editing software supplier.
Item 3. A print order receiving server, comprising:

a charging unit to calculate a charging amount to be charged to a supplier of the image editing software based on the print order information; and

a storing unit to store the charging amount in conjunction with the ID,

wherein the print order receiving server is capable of communicating with an order terminal which transmits a print order information including image information which is image edited, and an ID of an image editing software which realizes a function to edit the image information.
Item 4. A print order program storing medium comprising:

a function to operate a print order terminal as a transmission unit which transmits the print order information as well as an identification data (hereinafter called ID) of the image editing software,

Wherein, the print order terminal is capable of communicating with an order receiving server which receives print order information including image information and charges to an image editing software supplier, and the print order terminal provides an editing unit which is operated by an image editing software to edit the image information.

According to the present invention, the post-process based on an image editing software can be implemented at an order receiving side and in particular, charging to the image editing software supplier can be realized.

### BRIEF DESCRIPTION OF THE DRAWINGS

FIG. 1 is a block diagram of a print order system of the present embodiment.

FIG. 2 is a block diagram of computer portion of the print order terminal, the print order recipient server, and the printing company terminal provided in the print order system of the present embodiment.

FIG. 3 is a flow chart showing an outline of operation of the print order system of the present embodiment.

FIG. 4 is a block diagram indicating a functional configuration of the print order terminal of the present embodiment.

FIG. 5 is a schematic diagram showing a data structure of the print order information which is transmitted to the print order receiving server of the present embodiment.

FIG. 6 is a drawing showing the display screen displayed on the display unit when a recipient is selected in the present embodiment.

FIG. 7 is a block diagram showing functional configuration of the print order receiving server of the present embodiment.

FIG. 8 is a drawing illustrating the storing unit of the charging information for the image editing software supplier of the print order receiving server of the present embodiment.

FIG. 9 is a flow chart indicating operation of the print order terminal of the present embodiment.

FIG. 10 is a flow chart indicating operation of the print order receiving server of the present embodiment.

FIG. 11 is a drawing explaining the other embodiment to transfer an identification data of an image editing software and indicating a display screen displayed on a display unit of the print order terminal while the print order information is being transmitted.

### DETAILED DESCRIPTION OF THE PREFERRED EMBODIMENT

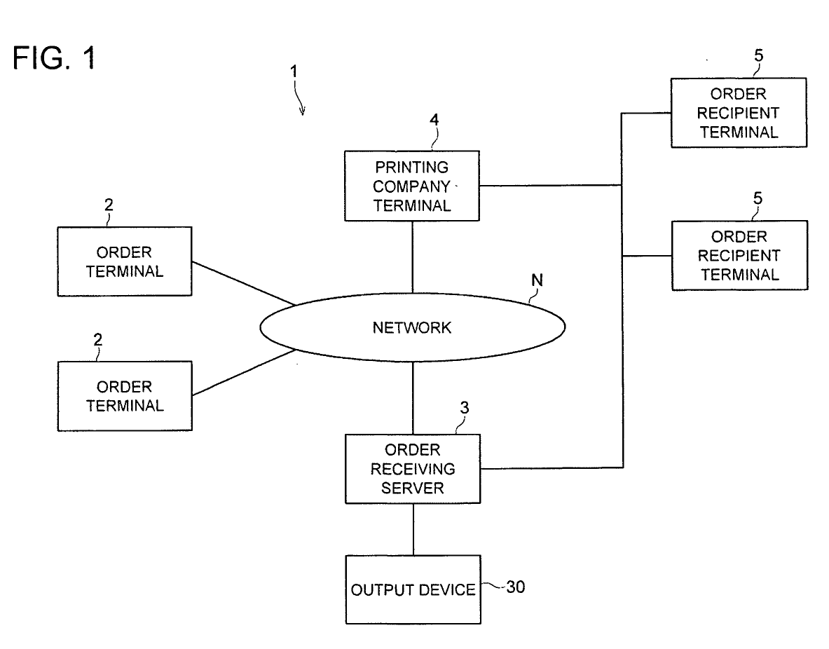

FIG. 1 is a block diagram of an print order system of an embodiment of the present invention. Order system 1 is a system in which an order of print from an orderer is received and printing is executed. Order system 1 is provided with a plurality of order terminals 2, order receiving server 3, printing company terminal 4 and a plurality of order recipient terminals 5. Order terminals 2, order receiving server 3 and printing company terminal 4 are arranged to be capable of connecting with network N.

Order terminal 2 is a terminal to be operated by an orderer who orders the print. Order terminal 2 edits the image and transmits print order information including image information of the image to be printed to order receiving server 3. Order receiving server 3 charges to the orderer and supplier of image editing software which operates order terminal 2 as the image editing unit, and transfers necessary information including image information to printing company terminal 4. Printing company terminal 4 makes a printed matter by outputting the transferred image information. The print is transmitted to designated order recipient terminal 5 and delivered to the orderer.

Outputting unit 30 to output image information can be connected to order receiving server 3 without interposition of network N. In this case outputting unit 30 can output the image information on a sheet.

Network N is an electronic communication circuit capable of transmitting electronic data. As the electronic communication circuit, for example, telephone circuit network, optical fiber network, exclusive line, mobile communication network, communication satellite network, CATV (cable TV) and LAN (local area network) or compound thereof are cited.

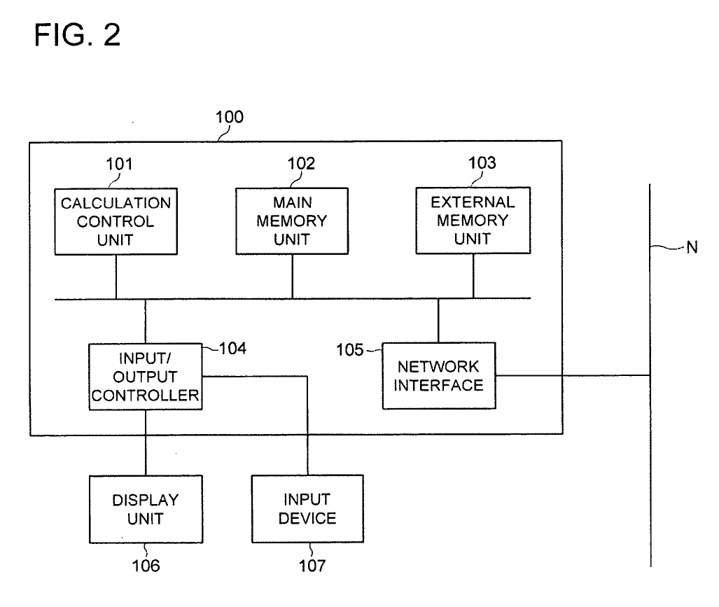

Order terminal 2, order receiving server 3, and printing company terminal 4 include computers. FIG. 2 is a block diagram of a computer portion of order terminal 2, order receiving server 3 and printing company terminal 4. Each of order terminal 2, order receiving server 3 and printing company terminal 4 is provided with computer unit 100 individually. Computer unit 100 makes calculation control unit 101, main memory unit 102, external memory unit 103 and input/output controller 104 possible to transmit and receive data each other through a bus line.

Calculation control unit 101 is so-called CPU and controls main memory unit 102, external memory unit 103, input/output controller 104 and network interface 105 according to a computer program. Main memory unit 102 becomes a work are of calculation control unit 101, where the computer program to be interpreted by calculation control unit 101 and data to be processed are developed in external memory unit 103. Computer programs to be interpreted by calculation control unit 101 and various data are stored. The input/output controller controls display unit 106 to display a display screen image and sends over input signals from input units such as a keyboard and a mouse unit to calculation control unit 101. Network interface 105, the so-called NIC (network interface card) transmits data to and receives data from network N.

Such order terminals 2, order receiving servers 3 and printing company terminals 4 are capable of communicating each other through network N using internet technologies such as WWW (world wide web) and TCP/IP. Order receiving server 3 can operate as a WWW server.

Order system 1 executes charging process for an added value offering service to an image editing software supplier. The added value offering service in the present embodiment is the offering of premiums such as an added value realized by offering printing order information forming program as API, added value that an order of printing can be placed with order system 1 from the image editing software, and an image editing software capable of utilizing the aforesaid services.

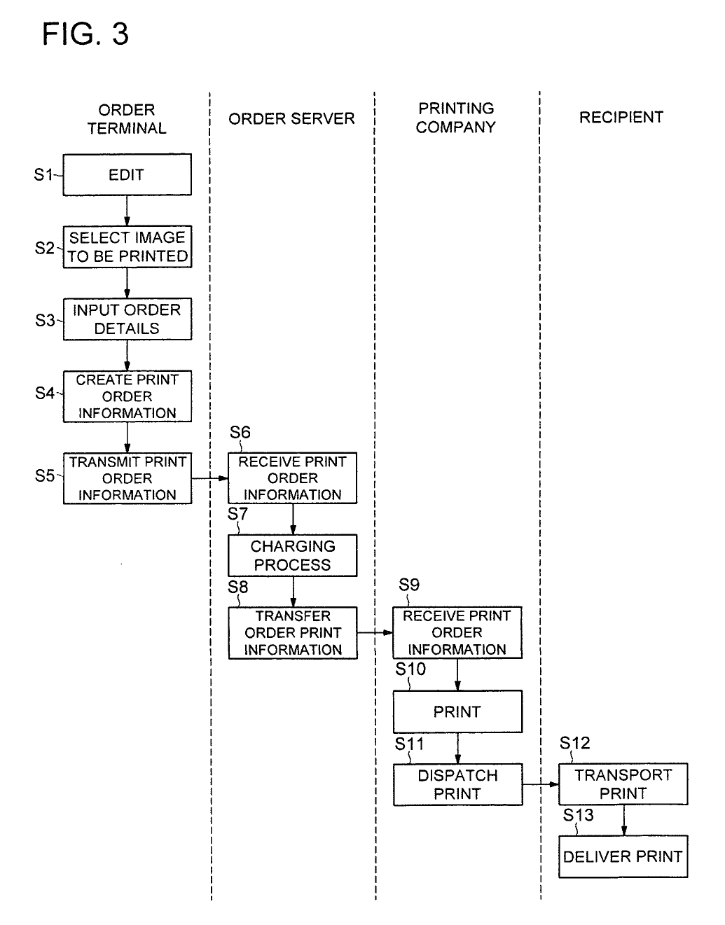

FIG. 3 is a flow chart of an outline of operation of order system 1. As shown in FIG. 3, order terminal 2 edits image information in response to the operation of the orderer (S1). To output the edited image information, in order terminal 2, the customer operates input unit 107 to select images to be printed (S2) and inputs the details of the order, e.g., a number of prints, a type and a size of printing sheet and a condition of finish (S3).

After the images to be printed are selected and order details are inputted, order terminal 2 creates print order information which indicates details of selections and input (S4). The print order information includes information which identifies the image editing software used for image editing. The print ordering information thus created is transmitted to order receiving server 3 through network N (S5).

In order receiving server 3, after print order information is received through network N (S6), charging process for the orderer and the aforesaid image editing software supplier is executed (S7) from the information which identifies the number of selected images, the details of the order and the image editing software used for image editing, then the print order information is transmitted to printing company terminal 4 after reconfiguring the print order information (S8).

The printing company receives the print order information transmitted by printing company terminal 4 through network N (S9), then it prints images based on image to be printed shown by print order information and on the details of the order (S10), and it transmits the prints to designated order recipient terminal 5(S11). In designated order recipient terminal 5, the print is delivered to the orderer (S13) after the print is delivered (S12). Meanwhile, printing company terminal 4 and designated order recipient terminal 5 may be separately installed in a different site or the printing company and the recipient can be combined at the same site.

In the aforesaid order system 1, external memory 103 of order terminal 2, stores an operation system program, an image editing program written in image editing software and print order program written in remote print driver software. In order terminal 2, these programs are developed to main memory 102 and calculation control unit 101 executes calculation, and controls for each of units from 101 to 105 so that each unit functions.

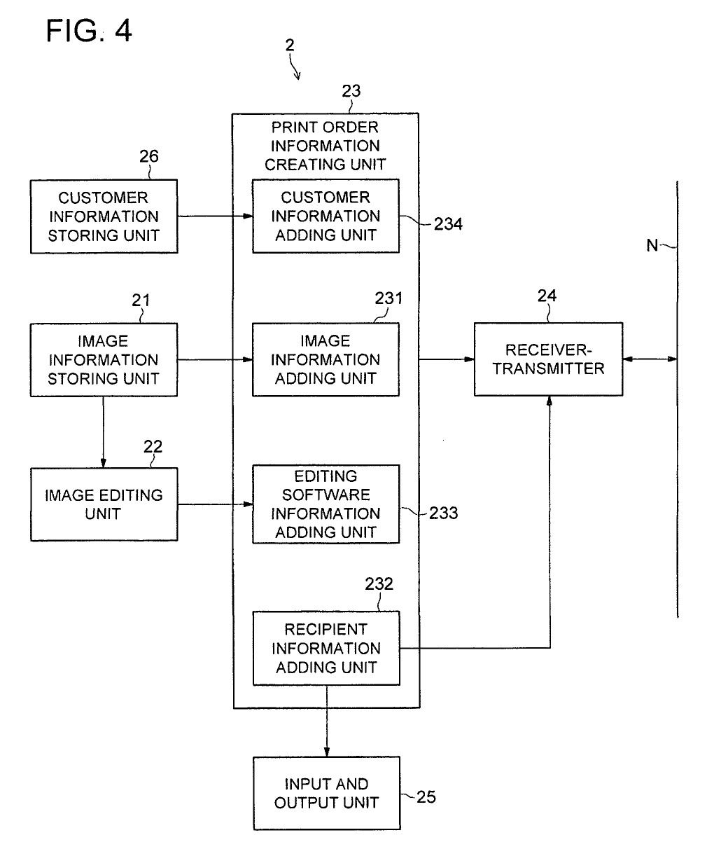

FIG. 4 is a block diagram showing functional configuration of order terminal 2. As FIG. 4 shows, order terminal 2 is provided with image information storing unit 21, image editing unit 22, print order information creating unit 23, data receiver-transmitter 24, input and output unit 25 and user information storing unit 26.

Image information storing unit 21 includes external memory unit 103 to store image information. The image information is a page description language such as Post Script and compressed data such as bit map data and Jpeg. Image information can be stored in a store media from which order terminal 2 can read out. For example, optical disk optical magnetic dick (CD-ROM, DVD-RAM, DVD-ROM and MO) magnetic storing media (hard disk, floppy disk(registered trade name) and ZIP) may store image information.

Image editing unit 22 is includes, for example, calculation control unit 101 which functions when an operator to starts the image editing software. Image editing unit 22 edits image information. Editing of image information includes layout of a print position of the image corresponding to the image information, inserting and designing of text and inserting of addresses. The image information which is a fundamental of editing work is read out from image information storing unit 21.

Print order information creating unit 23 including for example, calculation control unit 101 creates print order information which is sent to order receiving server 3. The print order information is information of a print order placed with order receiving server 3. Print order information creating unit 23 is provided with image information adding unit 231, a recipient information adding unit, editing software information adding unit 233 and user information adding unit 234 and creates print order information by adding various information as the print order information.

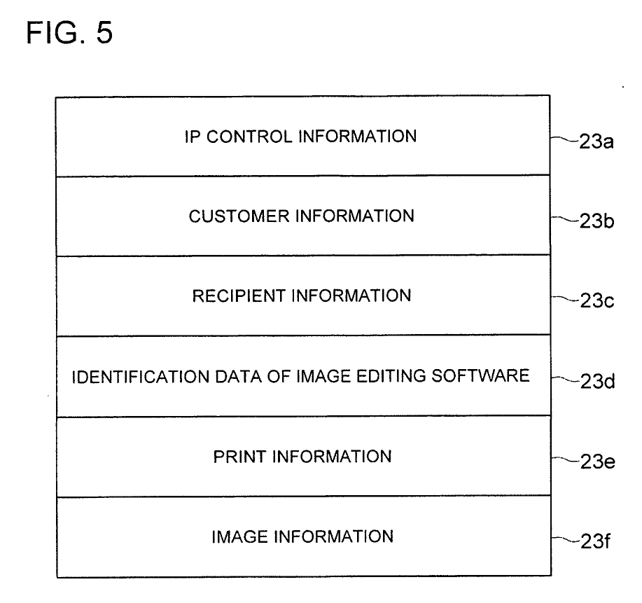

FIG. 5 is a diagram showing a data structure of the print order information sent to order receiving server 3 by receiver-transmitter 24. Print order information creating unit 23 adds IP control information 23a which includes a destination information of order receiving server 3 to print order information at a header thereof and adds user information 23b, recipient information 23c, editing software information 23d, print information 23e and image information 23f below the header.

Image information adding unit 231 adds image information 23f and print information 23e to the print order information. Image information 23f is selected from image information 23f stored in a storing media or image information storing unit 21 by the orderer using input unit 107. Print information 23e is constructed by a type namely size and quality of sheet where the image is printed, a printing number for each item of image information which is added to print order information and information of the condition of finish such as gloss, and is selected by the orderer using input unit 107,

User information adding unit 234 adds user information 23b to the print order information. User information 23b, stored in user information storing unit 26, specifies the orderer by address, name, telephone number and mail address to enable communications. User information storing unit 262 is constructed including, for example, external memory unit 103. User information adding unit 234 reads out user information 23b from user information storing unit 26 and adds to the print order information.

Recipient information adding unit 232 adds recipient information 23c to the print order information. Recipient information 23c is obtained by controlling receiver-transmitter 24 to communicate with order receiving server 3, and by selecting from registered recipients such as shops near the orderer using input and output unit 25. Input and output unit 25 is composed of display unit 106 and input unit 107.

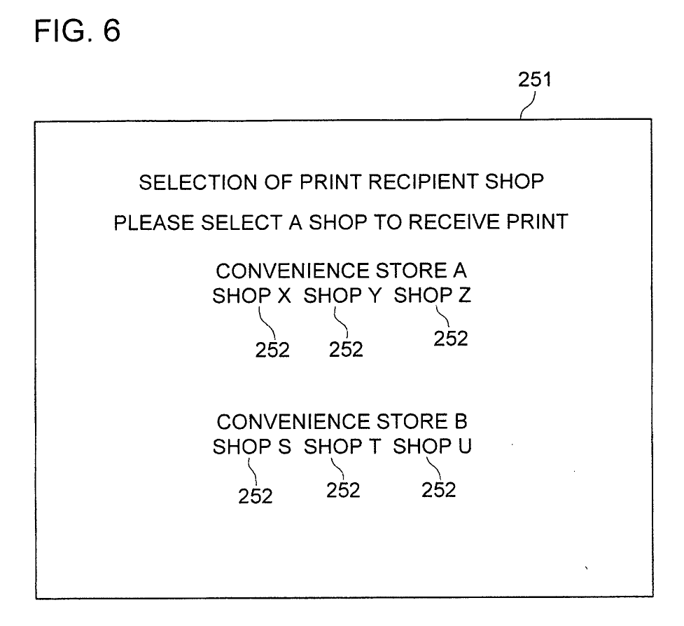

FIG. 6 is a diagram showing display screen 251 which is displayed in display unit 106 when a recipient is selected. Recipient information adding unit 232 reads out an address from user information storing device 26 and controls receiver-transmitter 24 to transmit the address to order receiving server 3. In order receiving server 3, the nearest recipient information 23c is retrieved from address transmitted and pertinent list 252 is responded to order terminal 2. Recipient information adding unit 232 controls input and output controller 104 to display list 252. When an orderer designates a recipient in the list using input device 107, the recipient information designated through input output controller 1004 is transmitted to recipient information adding unit 232.

Editing software information adding unit 233 adds ID (identification data) 23d of image editing software to the print order information. A print order information creating program is called by image editing software as API (Application Program Interface) to be used. In other word, editing software information adding unit 233 functions under control of image editing unit 22. Editing software information adding unit 233 readouts ID 23d of the image editing software from image editing unit 22 which is functioning simultaneously and adds ID 23d to the print order information.

ID 23d is a product name of image editing software and a name of the image editing software supplier and is information which can directly or indirectly identify a supplier of the image editing software that is calling up print order information creating unit 23.

Receiver-transmitter 24 includes, for example, network interface 105 and transmits transmission data created by print order information creating unit 23 to order receiving server 3 through network N. Also, receiver-transmitter 24 requests the list of recipient information to order receiving server 3 under control of recipient information adding unit 232 and receives list 252 of recipient information 23c as a response.

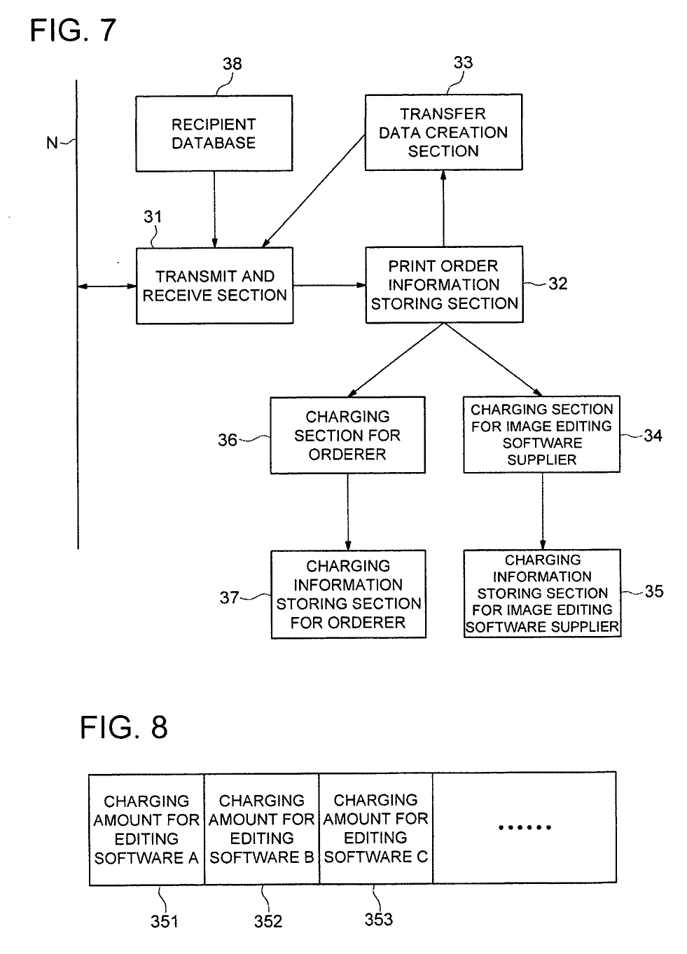

FIG. 7 is a block diagram showing a functional structure of order receiving server 3. Order receiving server 3 stores an order receiving program in external memory unit 103. Each function is realized when calculation control unit 101 execute a process following the order receiving program.

As FIG. 7 shows, order receiving server 3 receives the print order information from order terminal 2 through receiver-transmitter 31 and stores it in print order information storing unit 32. Receiver-transmitter 31 is composed including network interface 105 and print order information storing unit 32 is composed including external memory unit 103. The order receiving server 3 is provided with transmission data creating unit 33, editing software supplier charging unit 34, orderer charging unit 36 and recipient database 38.

Recipient database 38 is composed including external memory unit 103 and configures a database of shops capable of receiving prints as recipient information 23c. Also, recipient database 38 is composed including calculation control unit 101 and it retrieves potential shops capable of being a nearest recipient to the orderer from the information which indicates addresses transmitted by queries as a database control system, and then responds the list 252 of the shops.

Transfer data creating unit 33 is composed including calculation control unit 101 to transfer the print order information received from order terminal 2 to printing company terminal 4.

Editing software supplier charging unit 34 charges to the image editing software supplier for the added value offering service. Editing software supplier charging unit 34 is provided with editing software supplier charging information storing unit 35. FIG. 8 is a diagram explaining editing software supplier charging information storing unit 35. Editing software supplier charging information storing unit 35 including external memory unit 103 keeps a charging amount storage area 351 to 353 in conjunction with the information which directly or indirectly identifies the suppliers of various kinds of image editing software. The information which directly or indirectly identifies the suppliers of various image editing software is ID 23 for the image editing software in the present embodiment.

Charging unit for editing software supplier 34 reads out ID 23d for the image editing software from transmission data stored in print order information storing unit 32, and stores predetermined charging amount in charging amount storage area 351, 352 or 353 whichever corresponds to ID 23d, and a total charging amount is stored in case preceding charging amount is stored in advance. The charging amount is calculated from, for example, the number of prints for each image which is stipulated in print information 23e and type of sheet. Or, for example, a predetermined charging amount can be added for each receipt of the print order information.

As mentioned above, concerning editing software supplier charging unit 34 and editing software supplier charging information storing unit 35, charging procedure was explained in an example in which a fee is charged to the editing software supplier based on use of the image editing software. As other example, it is possible to conduct charging process to pay a charge for the image editing software to the editing software supplier based on use of the image editing software. Therefore, it is unimpeded that the charging amount summed by functions of editing software supplier charging unit 34 and editing software supplier charging information storing unit 35 is treated as a charge.

Orderer charging unit 36 readouts user information 23b and print information 23e from the print order information stored in print order information storing unit 32. The charging amount is calculated from the number of print for each image which is stipulated in print information 23e and from the kind of sheet. The calculated charging amount is stored in charging information storing unit 37 for orderer. Charging information storing unit 37 for orderer including external memory unit 103 stores user information 23b and the calculated charging amount in relation to one another.

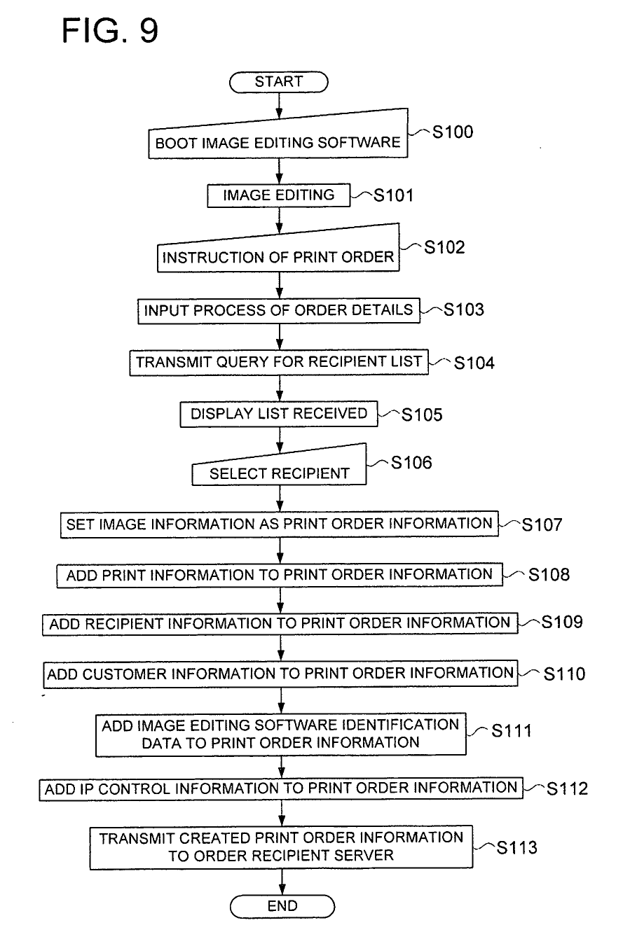

Detailed operation of order system 1 is explained unit by unit. FIG. 9 is a flow chart showing operation of order terminal 2. Order terminal 2 edits image information (S101) in response to the orderer's execution of image editing operation by starting an image editing software (S100). When a print order is selected and designated (S102) on the image editing software, the operation shifts to an input process of the order details (S103). The input process of the order details includes inputting of selection of desired image to be printed, the number of prints, the kind of sheet and the condition of finish.

When the details of order is inputted, order terminal 2 controls network interface 105 to transmit queries for list 252 of recipient information 23c by quires (S104). When list 252 of recipient information 23c is received, list 252 is displayed on display unit 106 (S105) to let the orderer to select recipient of the print (S106).

Next, when the orderer selects desired print image operating input unit 107, image information 23f corresponding to the selected image is readout from external memory unit 103 and is set as print order information (S107). Print information 23e such as set the number of prints, the kind of sheet and the condition of finish is added to the print order information (S108). Further, user information 23b is readout from external memory 103 and added to print order information (S110). Then ID 23d of image editing software which is calling up the print order information creating program that is ID 23d of the image editing software which is realizing image editing unit 22 that is controlling the image editing section 22 is added to print order information (S111).

Further, IP control information 23a including the recipient information of order receiving server 3 is added to the print order information (S112). The print order information to which various pieces of information are added is transmitted to order receiving server 3 through network N (S113).

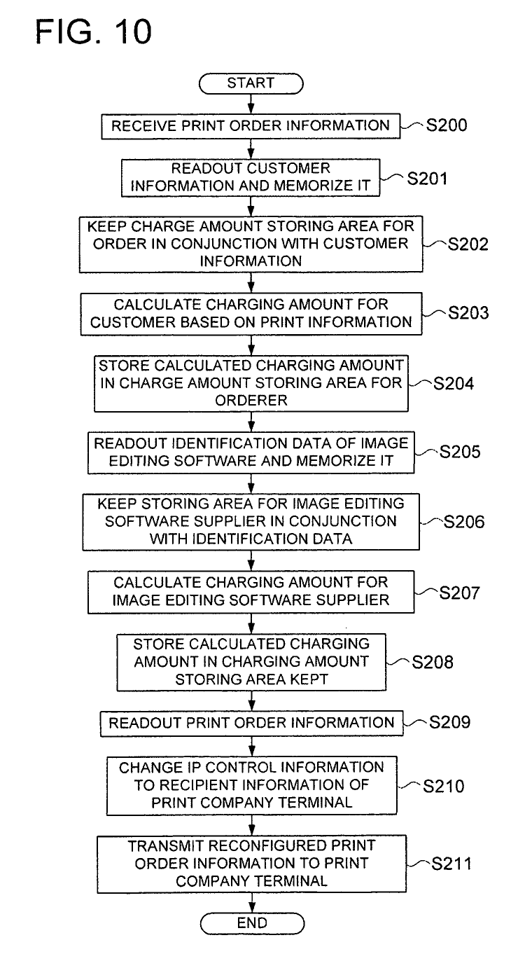

FIG. 10 is a flowchart showing operation of order receiving server 3. When order receiving server 3 receives the print order information from order terminal 2 (S200), the print order information is temporally stored in external memory unit 103. The print order information is queued as a job for charging process for the orederer, charging process for the supplier of the image editing software and a transmission process until the job is dequeue to proceed with the job.

In charging process for the orderer, user information 23b which is added to the print order information is read in and stored in external memory unit 103(S201). Then the charging amount storage area for the orderer is kept in conjunction with user information 23b, in external memory unit 103 (S202). Meanwhile, in case the same user information 24 is already stored or the charging amount storage area for the same user information 24 is already kept, this process is omitted.

After user information 23b is stored and charging amount for orderer storage area is kept, a total number of images desired to be printed, kind of the sheet and the condition of finish are read out from print information 23e which is attached to the print order information, and the charging amount for orderer is calculated (S203). Next, the calculated charging amount is stored in an secured charging amount storage area for the orderer (S204). In case the charging amount is already stored in the storage area, the amount in the area and the amount calculated this time are summed, and the summed amount is stored in the charging amount storage area.

In a charging process of image editing software supplier, ID 23d of the image editing software attached to print order information is read in first to be stored in external memory unit 103 (S205). Further, charging amount area 351, 352 or 353 for image editing software supplier (hereinafter charging amount storing is 351) is kept in external memory unit 103 in conjunction with ID 23d (S206). Meanwhile, in case the same ID 23d is already stored or charging amount storing area 351 for the same ID 23d is already kept, this process is skipped.

After ID 23d is stored and charging amount storage area 351 is kept, the charging amount for image editing software supplier is calculated (S207). For example, a total number of the images desired to be printed, kind of the sheet and the condition of finish are read from print information 23e which is attached to the print order information, and the amount to be claimed amount namely charging amount is calculated. Next, the calculated charging amount is stored in charging amount storage area 351 which is kept in advance (S208). In case the charging amount is already stored in storage area 351, the amount stored in the area and the amount calculated this time are summed, and the amount stored in charging amount storage area 351 is updated to the summed amount.

In a transfer process, the print order information stored in external memory unit 103 is read out (S209) to be reconfigured. IP control information 23a included in the print order information is converted to recipient information for printing company terminal 4 (S210), and a reconfigured print order information is transmitted to printing company terminal 4 through network N (S211).

Meanwhile, in order receiving server 3, a processing order of the charging process for orderer, the charging process for image editing software supplier and the transfer process can be unconstrained.

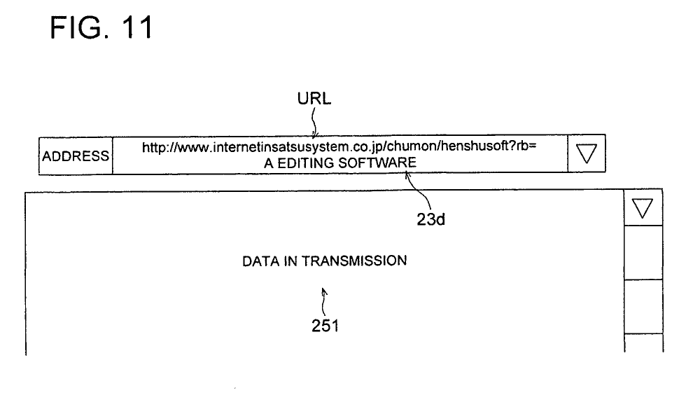

In order terminal 2, ID 23d of image editing software is attached to print order information as a data, as above mentioned. As a method to transmit ID 23d to order receiving server 3, for instance, embedding the aforesaid ID 23d in URL of order receiving server 3 is also possible. FIG. 11 is a diagram explaining another embodiment of transmitting ID 23d, and indicates a display screen 251 displayed on display unit 106 of order terminal 2 in the course of transmission of the print order information.

In this case, order receiving server 3 is WWW server, and charging unit 34 for image editing software supplier may be realized by CGI (Common Gateway Interface) script. An image editing software adding unit 233 of order terminal 2 can embed ID 23d in URL included in IP control information 23a.

As observed above, such order system 1 realizes a post-process based on image editing software at an order receiving side, and in particular, charging to the image editing software supplier is possible. Meanwhile, by solving an issue that the order receiving side identifies the image editing software used for image editing, processes other than the charging process are possible.

For example, an image editing software has an peculiar character in image editing and in a purpose of print for each product and each kind. For an image editing software specifically for new year greeting cards, the main purpose of printing is making new year greeting cards.

Transfer data creating unit 33 of order receiving server 3 is provided with a database where ID 23d and the details of post-process are stored in relation to one another. The database is composed including external memory unit 103. In a detail of process, the detail data to create the information which is added or corrected when transferred data is reconfigured is written. If ID 23d indicates a specific image editing software for making greeting cards, the correction details, which change kind of the sheet included in print information 23e to “greeting cards”, will be written in database.

Transfer data creation unit 33 reads in ID 23d included in the print order information, executes a process corresponding to ID 23d by referring to database and creates data to be attached to the transfer data or corrects the print order information. If ID 23d indicates a specific image editing software for making new year greeting cards, transfer data creation unit 33 corrects the information which changes the kind of sheet included in print information 23e as “greeting card” will be written in the database.

Also, as other image editing software, printer driver and application software to create PDF (Portable Document Format) format file are included in such kind of image editing software.

As described above, by solving an issue to identify image editing software used for image editing at order receiving side, order details can be corrected in accordance with image editing software, thus the needs of orderers can be precisely predicted to respond it, in addition to charging.

What is claimed is:

1. A print order system, comprising:
an order terminal to transmit print order information having image information, including;
an editing unit which is operated by an image editing software to edit the image information, and
a transmission unit which transmits the print order information with identification data (hereinafter called ID) of the image editing software;
an order receiving server to receive the print order information, including;
a charging unit to calculate a charging amount to be charged to an image editing software supplier based on the print order information, and
a storing unit to store the charging amount in conjunction with the ID.

2. A print order system of claim 1, wherein the print order information includes at least one of pieces of information on a kind of printing sheet, a number of printing sheets and a condition of finish.

3. A print order system of claim 1, wherein the print order information includes designation information of a recipient who receives a printed matter which is based on the image information.

4. A print order system of claim 1, wherein the order receiving server transfers the image information to a printing company terminal.

5. A print order system of claim 1, wherein the order receiving server is a WWW (World Wide Web) server.

6. A print order system of claim 1, wherein the transmission unit embeds the ID in a URL (Uniform Resource Locator) to transmit.

7. A print order terminal comprising:
an editing unit which is operated by an image editing software to edit image information; and
a transmission unit which transmits print order information with ID of the image editing software,
wherein the print order terminal is capable of communicating with an order receiving server which receives the print order information including the image information, and charges to an image editing software supplier.

8. A print order terminal of claim 7, wherein the print order information includes one of pieces of information on a kind of printing sheets, a number of prints and a condition of finish.

9. A print order terminal of claim 7, wherein the print order information includes designation information of a recipient who receives a printed matter which is based on the image information.

10. A print order terminal of claim 7, wherein the transmission unit embeds the ID in a URL to transmit.

11. A print order receiving server, comprising:
a charging unit to calculate a charging amount to be charged to an image editing software supplier based on print order information; and
a storing unit to store the charging amount in conjunction with ID of an image editing software,
wherein the print order receiving server is capable of communicating with an order terminal which transmits the print order information including image information which is an edited image, and the ID of the image editing software which edits the image information.

12. A print order receiving server of claim 11, wherein the print order information includes one of items of information on a kind of printing sheet, a number of prints and a condition of finish.

13. A print order receiving server of claim 11, wherein the print order information includes designation information of a recipient who receives a printed matter which is based on the image information.

14. A print order receiving server of claim 11, wherein the print order receiving server transfers the image information to a printing company terminal.

15. A print order receiving server of claim 11, wherein the print order receiving server is a WWW server.

16. A print order program storing medium comprising;
a function to operate a print order terminal as a transmission unit which transmits print order information with ID of an image editing software,
Wherein the print order terminal is capable of communicating with an order receiving server which receives the print order information including image information and charges to an image editing software supplier, and the print order terminal provides an editing unit which is operated by the image editing software to edit the image information.

17. A print order program storing medium of claim 16, further comprising
a function, wherein the print order information includes one of pieces of information on a kind of printing sheet, a number of prints and a condition of finish.

18. A print order program storing medium of claim 16, still further comprising
a function, wherein the print order information includes designation information of a recipient who receives a printed matter which is based on the image information.

19. A print order program storing medium of claim 16, yet further comprising
a function, wherein the transmission unit embeds the ID in a URL to transmit.
